(19) United States
(12) Patent Application Publication
(10) Pub. No.: US 2011/0075822 A1
(43) Pub. Date: Mar. 31, 2011

(54) INFORMATION PROCESSING APPARATUS, INFORMATION PROCESSING METHOD AND COMPUTER READABLE RECORDING MEDIUM STORING INFORMATION PROCESSING PROGRAM

(75) Inventor: Yoichi Susaki, Nagoya-shi (JP)

(73) Assignee: BROTHER KOGYO KABUSHIKI KAISHA, Nagoya-shi (JP)

(21) Appl. No.: 12/893,309

(22) Filed: Sep. 29, 2010

(30) Foreign Application Priority Data
Sep. 30, 2009 (JP) 2009-227703

(51) Int. Cl. H04M 11/00; H04M 1/56

(52) U.S. Cl. 379/93.01; 379/142.1

(57) ABSTRACT

An information processing apparatus includes: a first acquisition unit that acquires call identification information for identifying a caller during a call; a storage unit that stores first location information indicating a location on a network; a second acquisition unit that acquires, from the storage unit, the first location information corresponding to the acquired call identification information; a reception unit that receives, from another apparatus, display information which includes second location information indicating a location on the network of said another apparatus; a determination unit that determines whether the second location information received by the reception unit coincides with the first location information stored in the first storage unit; and a supply unit that supplies a display signal for displaying the received display information to a display unit during the call if the determination unit determines that the second location information coincides with the first location information.

### CROSS-REFERENCE OF APPLICATION

This application is based upon and claims the benefit of priority of Japanese Patent Application No. 2009-227703 filed on Sep. 30, 2009, the contents of which are incorporated herein by reference in its entirety.

### BACKGROUND OF THE INVENTION

The present invention relates to an information processing apparatus that performs a call with another person while displaying display information.

Recently, with the spread of the Internet, information terminals that can access the Internet have spread to every home. In the related art, a phone system having a display unit is known. Specifically, when a phone call is received, the phone number of the other party who has initiated the call is acquired. Among information stored in a storage unit of the phone system, an e-mail address that coincides with the acquired phone number is determined. The contents of the e-mail recently received are displayed based on the determined e-mail address.

### SUMMARY OF THE INVENTION

Even when responding to a phone call, it is sometimes desired to read display information such as e-mail or the like on a display unit. For example, while responding to a phone call, it may be desired to see display information sent from a calling party or the like.

Accordingly, an aspect of the present invention has been made to take into account the above-mentioned background, and the aspect of the present invention provides an information processing apparatus that can make it possible to read display information such as e-mail received during response to a phone call through a display unit even while responding to the phone call.

According to an aspect of the invention, an information processing apparatus includes:

a first acquisition unit that acquires call identification information for identifying a caller during a call;

a first storage unit that stores first location information indicating a location on a network,

a second acquisition unit that acquires, from the first storage unit, the first location information corresponding to the call identification information acquired by the first acquisition unit;

a reception unit that receives, from another apparatus that is connected to the information processing apparatus through the network, display information which includes second location information indicating a location on the network of said another apparatus;

a first determination unit that determines whether the second location information received by the reception unit coincides with the first location information stored in the first storage unit; and

a supply unit that supplies a display signal for displaying the display information received by the reception unit to a display unit during the call if the first determination unit determines that the second location information coincides with the first location information.

According to an aspect of the invention, an information processing method comprising:

acquiring call identification information for identifying a caller during a call;

acquiring, from a storage unit, first location information corresponding to the acquired call identification information;

receiving, from another apparatus that is connected to the information processing apparatus through the network, display information which includes second location information indicating a location on the network of said another apparatus;

determining whether the received second location information coincides with the acquired first location information; and

supplying a display signal for displaying the received display information to a display unit during the call if it is determined that the second location information coincides with the first location information.

According to an aspect of the invention, a computer readable recording medium stores a program for causing a computer to execute:

acquiring call identification information for identifying a caller during a call;

acquiring, from a storage unit, first location information corresponding to the acquired call identification information;

receiving, from another apparatus that is connected to the information processing apparatus through the network, display information which includes second location information indicating a location on the network of said another apparatus;

determining whether the received second location information coincides with the acquired first location information; and

supplying a display signal for displaying the received display information to a display unit during the call if it is determined that the second location information coincides with the first location information.

According to the aspect of the invention, the display information received during the response to the phone call can be provided to the display unit even while responding to the phone call.

### BRIEF DESCRIPTION OF THE DRAWINGS

FIG. 1 is a view illustrating an external appearance of an information processing apparatus 10 according to a first embodiment.

FIG. 2 is a block diagram illustrating an electrical configuration of an information processing apparatus 10 according to the first embodiment.

FIG. 3 is a conceptual view illustrating an example of a storage state of personal information stored in a personal information storage region 31.

FIG. 4 is a conceptual view illustrating a storage state of fax data stored in a fax data storage region 32.

FIG. 5 is a conceptual view illustrating a storage state of an e-mail stored in an e-mail data storage region 33.

FIG. 6 is a conceptual view illustrating an example of display information displayed by a touch panel display 12.

FIG. 7 (7A, 7B) is a flowchart illustrating a processing order of main operations in an information processing apparatus 10 according to the first embodiment.

FIG. 8 is a flowchart illustrating a processing order during response to a phone call in an information processing apparatus 10 according to the first embodiment.

FIG. 9 is a conceptual view illustrating an example of personal information stored in a personal information storage region 31 according to a second embodiment.

FIG. 10 is a conceptual view illustrating an example of fax data stored in a fax data storage region 32 according to the second embodiment.

FIG. 11 is a conceptual view illustrating an example of e-mail data stored in an e-mail data storage region 33 according to the second embodiment.

FIG. 12 (12A, 12B) is a flowchart illustrating a processing order of main operations in an information processing apparatus 10 according to the second embodiment.

FIG. 13 is a flowchart illustrating a processing order during response to a phone call in an information processing apparatus 10 according to the second embodiment.

### DETAILED DESCRIPTION OF EXEMPLARY EMBODIMENTS

### First Embodiment

Hereinafter, a first embodiment will be described based on drawings.

### External Appearance of Information Processing Apparatus According to First Embodiment

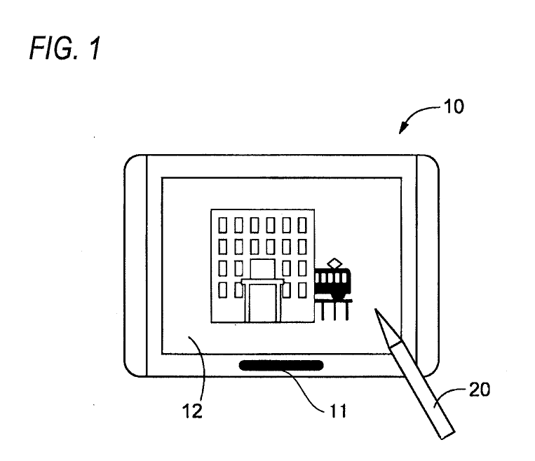

As illustrated in FIG. 1, an information processing apparatus 10 includes a touch panel display 12 and a calling unit 11. The information processing apparatus 10 includes a pen 20. The pen 20 may not be provided in the information processing apparatus 10.

Predetermined display information can be displayed on the touch panel display 12, and predetermined information can be input to the touch panel display 12 according to a user's touch manipulation. A known touch panel is used in the touch panel 12.

The calling unit 11 enables a user of the information processing apparatus 10 to communicate with another person using a telephone line or Internet line. The calling unit 11 includes an audio input unit 13 and an audio output unit 14. The audio input unit 13 receives an input of user's audio information. The audio output unit 14 outputs audio information of another person received using the telephone line or Internet line. The audio information input by the audio input unit 13 is transmitted to another person using the telephone line or Internet line. The audio information output by the audio output unit 14 is the audio information transmitted from another person to the user. The calling unit 11, for example, is a general phone. In this embodiment, the calling unit 11 is connected to the telephone line. In this case, the audio input unit 13 and the audio output unit 14 are included in the calling unit 11. Accordingly, the audio input unit 13 and the audio output unit 14 are not specifically illustrated in FIG. 1.

The pen 20 is a pen for contact-operating the touch panel display 12. The pen 20 is not specifically limited if it is a member that is contactable with the touch panel display 12. Further, the pen 20 may not be provided and the user can directly manipulate the touch panel display with his/her finger.

Electrical Configuration of Information Processing Apparatus 10 according to First Embodiment

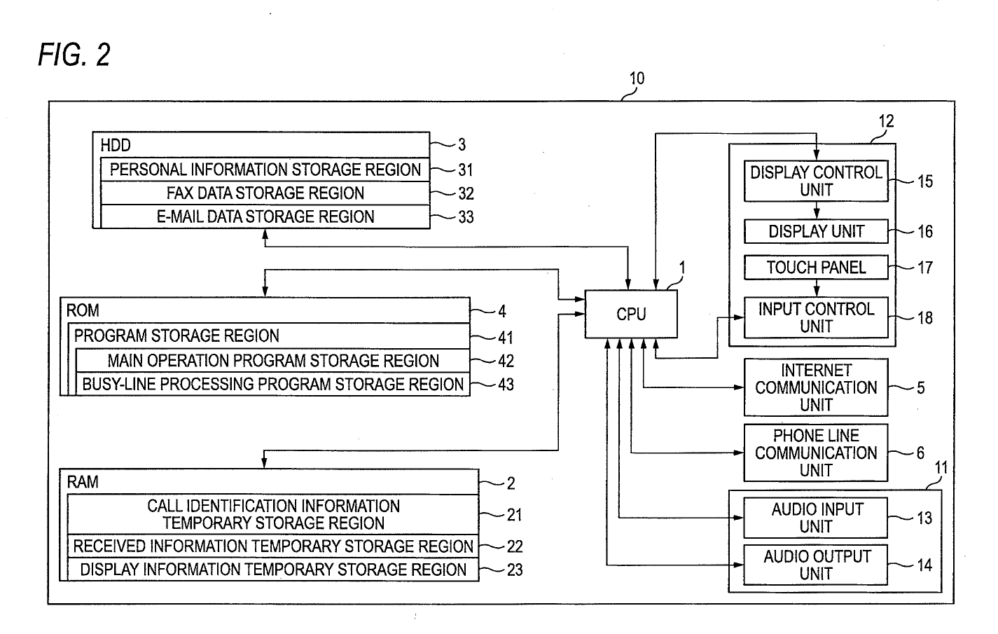

As illustrated in FIG. 2, the information processing apparatus 10 according to the first embodiment includes a CPU 1 that controls the information processing apparatus 10. A RAM 2, an HDD 3, a ROM 4, an Internet communication unit 5, a phone line communication unit 6, a calling unit 11, and a touch panel display 12 are electrically connected to the CPU 1. The storage unit, such as the RAM 2, the HDD 3, and the ROM 4, and the CPU 1 constitute a part of a computer of the information processing apparatus 10. The computer controls the operation of the information processing apparatus 10. In this case, although not illustrated, the information processing apparatus 10 has a function of transmitting and receiving a fax signal through the phone line communication unit 6. The function of transmitting and receiving the fax signal is the known fax function.

Specifically, the touch panel display 12 includes a display control unit 15, a display unit 16, a touch panel 17, and an input control unit 18. The display control unit 15 and the input control unit 18 are electrically connected to the CPU 1. The display control unit 15 is electrically connected to the display unit 16. The input control unit 18 is electrically connected to the touch panel 17.

The calling unit 11 includes the audio input unit 13 and the audio output unit 14. The audio input unit 13 and the audio output unit 14 are electrically connected to the CPU 1.

The RAM 2 includes a call identification information temporary storage region 21, a received information temporary storage region 22, and a display information temporary storage region 23.

The call identification information temporary storage region 21 is configured to temporarily store call identification information. The call identification information is information that indicates the other party in the call through the calling unit 11. In the first embodiment, the call identification information is a phone number. This phone number may be the phone number of a fixed phone or the phone number of a portable phone. The phone number may be a phone number of an IP phone. However, the call identification information is not limited to a phone number, and may be information that indicates the other party in the call. For example, the call identification information may be an ID that indicates the other party in the call.

The received information temporary storage region 22 is configured to temporarily store received fax data or e-mail data. The details of the fax data or e-mail data will be described later. The fax data or e-mail data is information that is transmitted to the information processing apparatus 10 through the Internet line 5 or the phone line communication unit 6. In the first embodiment, for example, the fax data or e-mail data is image information of the fax or e-mail. For example, it is image information of the fax generally print-output. The fax or e-mail received by the information processing apparatus 10 is temporarily stored in the received information temporary storage region 22. Generally, an e-mail includes e-mail text information and an attached file. The e-mail text information is text information transmitted through the e-mail. The attached file is a file attached to the e-mail text information to be transmitted. In this embodiment, the e-mail text information and the attached file are temporarily stored in the received information temporary storage region 22. The fax data received by the information processing apparatus 10 is temporarily stored in the received information temporary storage region 22. In this case, the received information temporary storage region 22 is configured to temporarily store an e-mail address of the sender that has transmitted the e-mail data together with the e-mail data received by the information processing apparatus 10. The e-mail address that is stored in the received information temporary storage region 22 may be an e-mail address for a general computer to transmit or receive an e-mail. It may be an e-mail address of a portable phone. It is sufficient if the e-mail address is an address for transmitting and receiving an e-mail or for transmitting and receiving information through a network, and the e-mail address stored in the received information temporary storage region 22 is not specifically limited.

In the first embodiment, it is exemplified that an e-mail is described as an example of received information. However, the received information is not limited thereto, and for example, it may be display information directly transmitted by an application except for e-mail software without passing through the e-mail. Image information such as a photo and so on directly transmitted without passing through the e-mail or a data file such as a document or announced data may be stored in the received information temporary storage region 22 as display information. The received information may also be a data file such as music and so on.

Information extracted from the fax data or the e-mail data received in the past, which are stored in the HDD 3, is temporarily stored in the display information temporary storage region 23. The calling unit 11 extracts the fax data or e-mail data received in the past based on the call destination or origination. The extracted information is temporarily stored in the display information temporary storage region 23. The details of the extraction method will be described later.

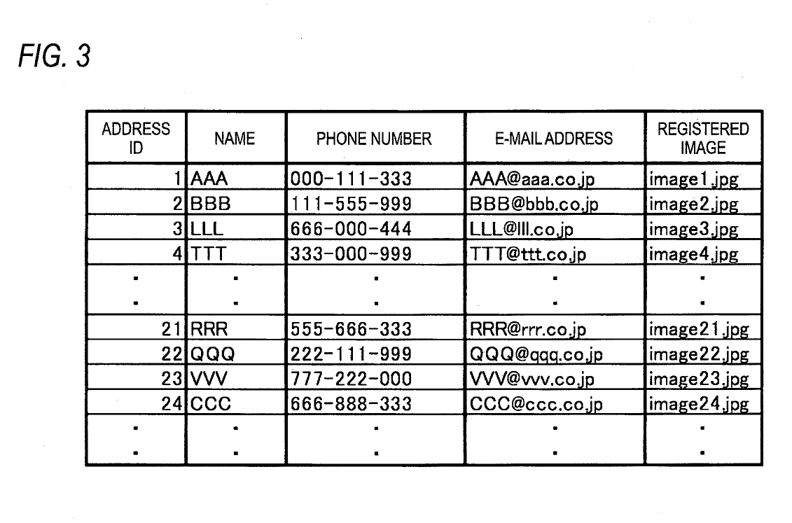

The HDD 3 includes a personal information storage region 31, a fax data storage region 32, and an e-mail data storage region 33. The personal information storage region 31 is configured to store personal information such as the other party in the call and so on. As illustrated in FIG. 3, the personal information includes an address ID, a name, a phone number, an e-mail address, and a registered image. The address ID is identification information that indicates the order of registration of personal information or the registration number of the personal information. The name is information that indicates the name of the other party in the call registered as the personal information. The phone number is information that indicates the phone number of the other party in the call. The e-mail address is information that indicates an e-mail address of the other party in the call and so on. The registered image is image information that indicates the other registered party in the call and so on as personal information. In this case, a nonvolatile memory may be used instead of the HDD 3. For example, the nonvolatile memory is a flash memory. The phone number stored in the personal information storage region 31 may be the phone number of a fixed phone or the phone number of a portable phone. The phone number may be the phone number of an IP phone. However, the call identification information is not limited to a phone number. It is sufficient if the call identification information is information that indicates the other party in the call. For example, the call identification information may be an ID that indicates the other party in the call. The e-mail address stored in the personal information storage region 31 may be an e-mail address for transmitting and receiving an e-mail in a general computer. The e-mail address may be the e-mail address of a portable phone. It is sufficient if the e-mail address is an address for transmitting and receiving an e-mail or for transmitting and receiving information through a network, and the e-mail address stored in the personal information storage region 31 is not specifically limited. In FIG. 3, it is exemplified that one e-mail address is stored to correspond to a phone number stored in the personal information storage region 31. It is also possible that one or more e-mail addresses may be stored to correspond to a phone number stored in the personal information storage region 31. One or more phone numbers may be stored to correspond to an address ID or a name stored in the personal information storage region 31.

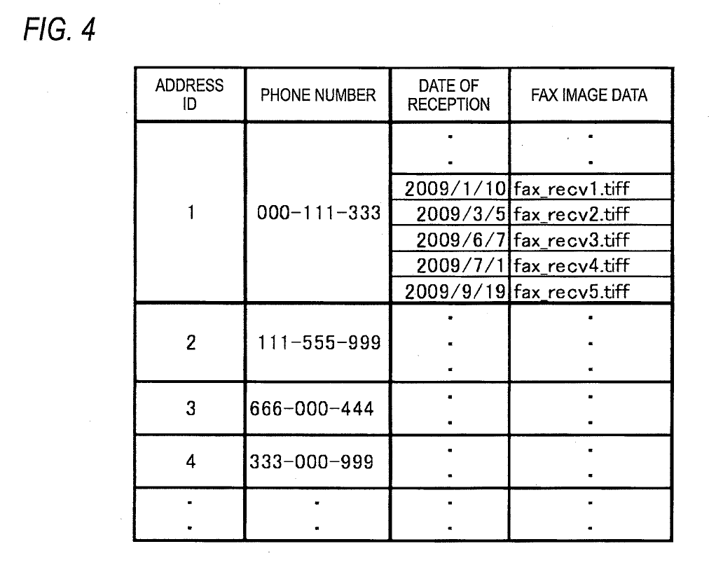

The fax data storage region 32 is configured to store the fax data received by the information processing apparatus 10. Although not described in detail in the first embodiment, the fax data is received through the phone line communication unit 6. The configuration for receiving the fax data is not specifically illustrated. The configuration for receiving the fax data is the same as the configuration of a known fax. As illustrated in FIG. 4, the fax data includes an address ID, a phone number, the date of reception, and fax image data. The address ID and the phone number are the same as the address ID and the phone number as illustrated in FIG. 3, respectively. The date of reception is information that indicates the date on which the fax is received. As illustrated in FIG. 4, date information “2009/1/10” on which the fax is received is stored in the fax data storage region 32 to correspond to the image data of the received fax. The fax image data is image information of the received fax. In the first embodiment, the received fax image data is stored in the fax data storage region 32 as an image in the form of “.tiff”.

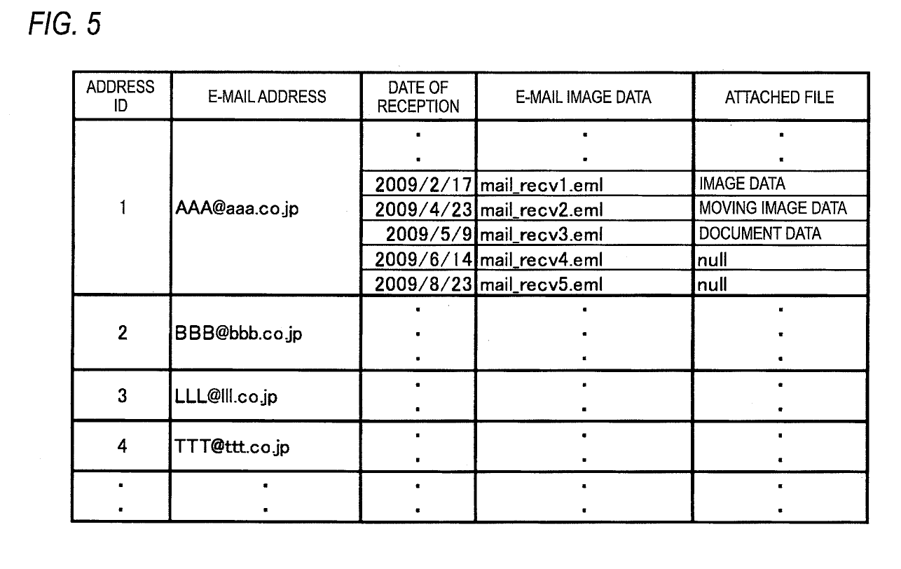

The e-mail data storage region 33 is configured to store e-mail data received by the information processing apparatus 10. In the first embodiment, the received e-mail data is received through the Internet communication unit 5. As illustrated in FIG. 5, the e-mail data includes an address ID, an e-mail address, the date of reception, e-mail image data, and an attached file. The address ID and the e-mail address are the same as the address ID and the e-mail address as illustrated in FIG. 3, respectively. The date of reception is information that indicates the date on which the e-mail is received. As illustrated in FIG. 5, date information “2009/2/17” on which the e-mail is received is stored in the e-mail data storage region 33 to correspond to the received e-mail image data. The e-mail image data is image information of the received e-mail. In the first embodiment, the e-mail image data of the received e-mail is stored in the e-mail data storage region 33. A general e-mail includes a header and text information. The header includes at least the title of a mail, the name of a sender who has sent the mail, the mail address. As the header, the date the mail was sent or the mail address of the mail recipient may be included. On the other hand, the text information is information that indicates the text of a mail input by a sender. In this embodiment, the e-mail image data includes the header and the text information. It is sufficient if the e-mail image data includes at least the text information. The attached file is a file attached to the received e-mail. If the received e-mail has an attached file, the attached file is stored in the e-mail data storage region 33 to correspond to the e-mail image data as illustrated in FIG. 5. If the received e-mail has no attached file, “null” that indicates there is no attached file is stored to correspond to the received e-mail image data as illustrated in FIG. 5. Information that is stored as the attached file, as illustrated in FIG. 5, may be image data, moving image data, music data, document data, or the like. The image data includes a photo and so on. The document data is document data composed of text or the like or slide data for announcement.

The ROM 4 includes a program storage region 41. The program storage region 41 includes a main operation program storage region 42 and a busy-line processing program storage region 43. The main operation program storage region 42 is configured to store a main operation program of the information processing apparatus 10. The main operation program is a program for controlling the information processing apparatus 10. The busy-line processing program storage region 43 is configured to store a busy-line processing program. The busy-line processing program is a program that is executed during a call through the calling unit 11.

The Internet communication unit 5 connects the information processing apparatus 10 to the Internet. The Internet communication unit 5 performs transmission and reception of information with another apparatus through the network.

The phone line communication unit 6 connects the information processing apparatus 10 to a phone line. The phone line is a known phone line. The phone line communication unit 6 performs a call or faxing with another apparatus through the phone line.

The calling unit 11 performs a call with another apparatus through the phone line communication unit 6. The calling unit 11 includes the audio input unit 13 and the audio output unit 14. The audio input unit 13 is configured to input audio, i.e. voice of a user of the information processing apparatus 10. For example, it may be a known microphone. The audio input through the audio input unit 13 is acquired by the information processing apparatus 10 as audio information. The acquired audio information is transmitted to another apparatus through the phone line communication unit 6. The audio output unit 14 outputs audio information received through the phone line communication unit 6. For example, the audio output unit 14 is a speaker. The audio information received from another apparatus through the phone line communication unit 6 is output through the audio output unit 14.

The touch panel display 12 includes the display control unit 15, the display unit 16, the touch panel 17, and the input control unit 18. The display control unit 15 generates a display signal that is supplied to the display unit 16. The display signal generated by the display control unit 15 is generated based on the display information or image information stored in storage means such as RAM 2, HDD 3, or the like. The display unit 16 performs a display based on the display signal supplied from the display control unit 15.

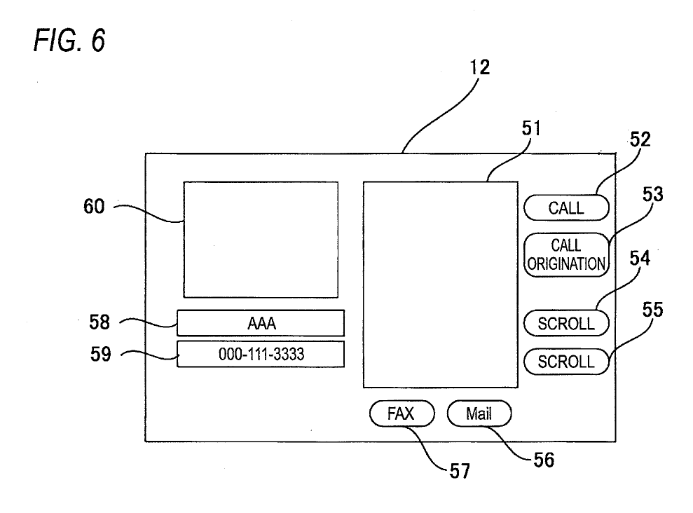

The input control unit 18 receives an input signal that is input through contact with the touch panel 17. Based on the input signal through contact and the contact position of the touch panel 17, the input control unit 18 performs a predetermined processing operation. As illustrated in FIG. 6, the touch panel display 12 includes a received display information display region 51, a caller name display region 58, a call location phone number display region 59, and the other party in the call image display region 60. The received display information display region 51 is a region for displaying an e-mail or fax data received by the information processing apparatus 10. The caller name display region 58 is a region for displaying the name of a calling party currently calling. The call location phone number display region 59 is a region for displaying the currently calling phone number. The other party in the call image display region 60 is a region for displaying image information of a calling party currently calling. The other party in the call image information is information stored in the personal information storage region 31 as a registered image.

The touch panel display 12 includes a call button display region 52, a send button display region 53, a scroll button display region 54, a scroll button display region 55, an e-mail display button display region 56, and a fax display button display region 57. By contacting the button display region with a user's pen 20 and so on, a predetermined processing operation is performed. The call button display region 52 corresponds to a button for performing a call when a call destination from another person is made in the information processing apparatus 10 through the phone line. The send button display region 53 corresponds to a button for making a call from the information processing apparatus 10 to another person with a phone number designated by a user. The fax display button display region 57 corresponds to a button for displaying fax data stored in the fax data storage region 32. The e-mail display button display region 56 corresponds to a button for displaying e-mail data stored in the e-mail data storage region 33. The scroll button display region 54 or the scroll button display region 55 corresponds to a button for scrolling the display information displayed on the received display information display region 51. When a plurality of display information is displayed on the received display information display region 51, the display of the plurality of display information can be shifted by contacting the scroll button display region 54 or the scroll button display region 55. When a user contacts such buttons, the above-described processing operation is controlled by the input control unit 18. The touch panel 17 is a known touch panel.

In this case, the program stored in the HDD 3 may be downloaded, for example, from a predetermined server on the network through the Internet communication unit 5. The program may be written in a recording medium such as a CD-ROM and may be read through a drive of the corresponding recording medium.

Main Processing Operation of Information Processing Apparatus 10 according to First Embodiment

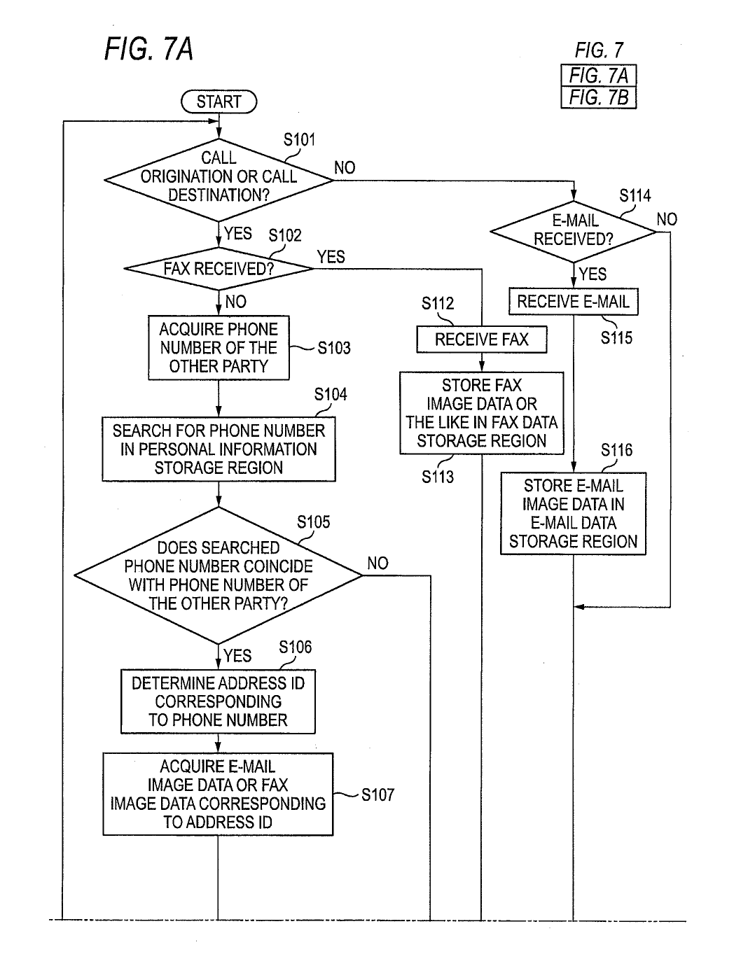

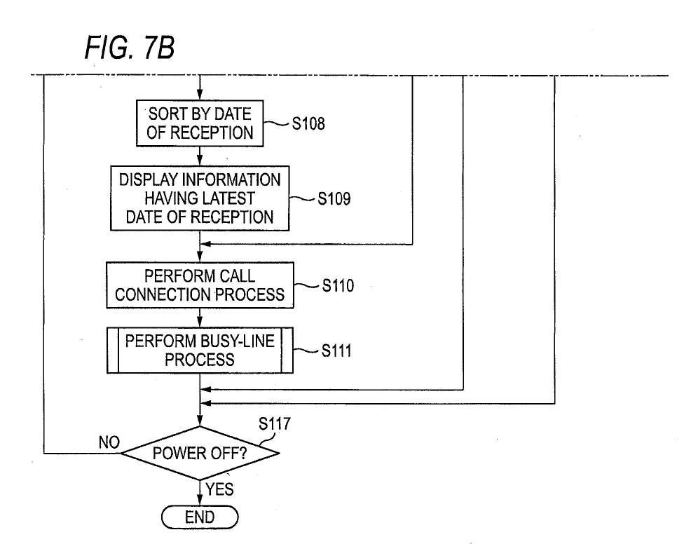

The operation and effect of the information processing apparatus 10 according to the first embodiment as configured above will be described with reference to the accompanying drawings. The main processing operation as illustrated in FIG. 7 is performed according to a main processing operation program. Based on the power-on of the information processing apparatus 10, the main processing operation of the information processing apparatus 10 is performed. The CPU 1 executes the main operation program. The processing described below is performed by the CPU 1.

S101 determines whether a call or fax is received from another apparatus to the information processing apparatus 10, or whether a call or fax is originated from the information processing apparatus 10 to another apparatus. First, the call or fax destination through the phone line communication unit 6 is received in the information processing apparatus 10. When the call or fax information is received through the phone line communication unit 6, it is determined that the call or fax has been received. On the other hand, in the call or fax send, a phone number is first determined by a user. Then, by contacting a send button display region 53, the call or fax is originated to the determined phone number as a recipient. Accordingly, when the send button display region 53 is contacted, it is determined that the call or fax has been originated. If it is determined that the call or fax has been received, or the call or fax has been originated, step S102 is performed. If it is not determined that the call or fax has been received, or the call or fax has been originated, step S114 is performed.

In step S102, it is determined whether the fax has been received by the information processing apparatus 10. Whether the fax has been received is determined by whether the fax data has been received through the phone line communication unit 6. If it is determined that the fax has been received, step S112 is performed. If it is not determined that the fax has been received, step S103 is performed.

In step S103, a phone number of the other party in the call is acquired. In the case of a call destination, another apparatus that has originated the call transmits the phone number of another apparatus to the information processing apparatus 10. The phone number transmitted to the information processing apparatus 10 is acquired in step S103. The acquired phone number is temporarily stored in the call identification information temporary storage region 21. On the other hand, in the case of a call, the phone number determined as the originator in step S101 is temporarily stored in the call identification information temporary storage region 21.

In step S104, it is searched for whether the phone number that coincides with the phone number acquired in step S103 is stored in the personal information storage region 31. Specifically, the phone number stored in the call identification information temporary storage region 21 is compared with the phone number stored in the personal information storage region 31.

S105 determines whether or not a coincident phone number exists as a result of search in step S104. If the phone number stored in the call identification information temporary storage region coincides with the phone number stored in the personal information storage region 31 as a result of comparison in step S104, it is determined that the coincident phone number exists. When it is determined that the coincident phone number exists, step S106 is performed. If it is not determined that the coincident phone number exists, step S110 is performed.

In step S106, an address ID of the phone number that is determined as the coincident phone number in step S105 is determined. Hereinafter, explanation will be made on the assumption that the address ID determined in step S105 is “1”.

In step S107, fax image data that corresponds to the address ID determined in step S106 and the date of reception are acquired from the fax data storage region 32. e-mail image data that corresponds to the address ID and the date of reception are acquired from the e-mail data storage region 33. Specifically, fax image data, such as “fax_recv1.tiff”, “fax_recv2.tiff”, or the like, which is the fax image data corresponding to the address ID “1”, is acquired. In the same manner, “image data”, “moving image data”, or the like, which is the e-mail image data corresponding to the address ID “1”, is acquired. The acquired data is temporarily stored in the display information temporary storage region 23.

In step S108, information acquired in step S107 are sorted based on the dates of reception which are temporarily stored in the display information temporary storage region 23. Specifically, extracted information are sorted in the order of their dates of reception, e.g. from the latest information.

In step S109, information having the latest date of reception among information sorted in step S108 is displayed on the received display information display region 51. In the first embodiment, it is exemplified that information having the latest date of reception is displayed. However, the number of information is not limited thereto, and a predetermined number of information may be determined to be displayed in the order of their date of reception, starting from the latest date of reception. In this case, the determined information is displayed on the received display information display region 51. In step S109, the fax image data or the e-mail image data having the latest date of reception is acquired from the display information temporary storage region 23, and then is displayed on the received display information display region 51.

In step S110, a phone connection processing is performed. The phone connection processing is connection processing for communicating with the other party in the call that has made the call destination or call origination in step S110. By performing the connection processing, the communication with the other party in the call becomes possible.

In step S111, busy-line processing is performed. The details of the busy-line processing will be described later.

In step S112, the fax image data is received. The received fax image data includes a phone number of a fax transmitter and fax image data.

In step S113, the fax image data received in step S112 is stored in the fax data storage region 32. Specifically, the date of reception when the fax is received in step S112 is acquired. The date of reception, although not illustrated, is date information determined by the information processing apparatus 10. This date information may be set by a user of the information processing apparatus, or may be automatically set through the Internet. The address ID that corresponds to the phone number included in the received fax is determined among the personal information storage region 31. In correspondence to the phone number included in the received fax or determined address ID, the fax image data and the date of reception are stored in the fax data storage region 32.

In step S114, it is determined whether the e-mail has been received by the information processing apparatus 10. If it is determined that the e-mail has been received, step S115 is performed. If it is not determined that the e-mail has been received, step S117 is performed.

In step S115, the e-mail image data is received. The received e-mail includes an e-mail address of an e-mail transmitter and e-mail image data. If an attached file is attached to the e-mail, the attached file is received.

In step S116, the e-mail received in step S115 is stored in the e-mail data storage region 33. Specifically, in step S115, the date of reception when the e-mail is received is acquired. The date of reception, although not illustrated, is date information determined by the information processing apparatus 10. This date information may be set by a user of the information processing apparatus, or may be automatically set through the Internet. The address ID that corresponds to the e-mail address included in the received e-mail is determined among the personal information storage region 31. In correspondence to the e-mail address included in the received e-mail or determined address ID, the e-mail image data, the attached file, and the date of reception are stored in the e-mail data storage region 33.

In step S117, it is determined whether the power of the information processing apparatus 10 is turned off. It is determined whether the power provided in the information processing apparatus 10 is turned off. If it is determined that the power is turned off, the main processing operation is ended. If it is not determined that the power is turned off, the step S101 is re-performed.

### Busy-Line Processing According to the First Embodiment

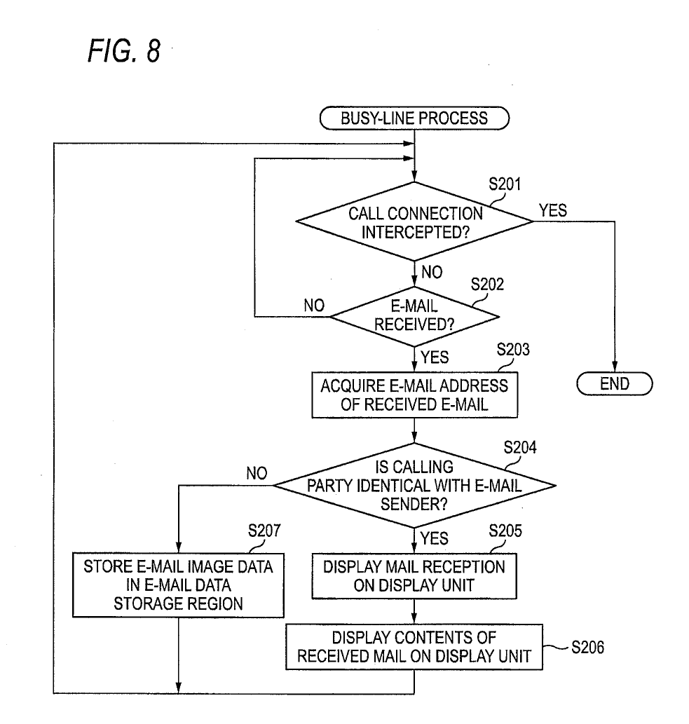

The busy-line processing as illustrated in FIG. 8 is performed according to a busy-line processing program. In step S201, it is determined whether the phone connection performed in step S110 is disconnected. Specifically, if the information processing apparatus 10 does not transmit or receive information through the phone line communication unit 6 over a predetermined time period, it is determined that the phone connection is disconnected. When the phone connection is determined to be disconnected, the busy-line processing is ended. If it is not determined that the phone connection is not disconnected, step S202 is performed.

In step S202, it is determined whether the e-mail is received through the Internet communication unit 5. If it is determined that the e-mail is received, step S203 is performed. If it is not determined that the e-mail is received, step S201 is re-performed.

In step S203, the e-mail address of the e-mail received in step S202 is acquired. Specifically, the e-mail received in step S202 is temporarily stored in the received information temporary storage region 22. The e-mail received in step S202 includes the header and text information as described above. The header includes the e-mail address of the e-mail transmitter. The e-mail address included in the header is acquired. The e-mail address is temporarily stored in the received information temporary storage region 22. In the received information temporary storage region 22, at least text information is stored as the e-mail image data. If the attached file is attached to the e-mail, the attached file is also temporarily stored in the received information temporary storage region 22.

In step S204, it is determined whether the transmitter of the e-mail address received in step S203 coincides with the other party in the call. Specifically, an e-mail address that coincides with the e-mail address acquired in step S203 among the personal information storage region 31 is searched for. If the e-mail address that coincides with the e-mail address acquired in step S203 exists in the personal information storage region 31, the address ID of the coincident e-mail address is acquired. This address ID is called an e-mail address ID. On the other hand, a phone number that coincides with the phone number stored in the call identification information temporary storage region 21 among the personal information storage region 31 is searched for. If the phone number that coincides with the phone number stored in the call identification information temporary storage region 21 exists in the personal information storage region 31, the address ID of the coincident phone number is acquired. This address ID is called the other party in the call address ID. If the e-mail address ID coincides with the other party in the call address ID, it is determined that the transmitter of the e-mail address coincides with the other party in the call. If it is determined that the transmitter of the e-mail address coincides with the other party in the call, step S205 is performed. If it is not determined that the transmitter of the e-mail address coincides with the other party in the call, step S207 is performed. At this time, if the e-mail address that coincides with the e-mail address acquired in step S203 does not exist in the personal information storage region 31, it is determined that the transmitter of the e-mail address does not coincide with the other party in the call in step S204.

In step S205, information that indicates that an e-mail is received from the other party in the call during the call is displayed on the display unit 16 by the display control unit 15.

In step S206, the e-mail image data that is temporarily stored in the received information temporary storage region 22 is displayed on the display unit 16. The e-mail image data displayed in step S206 is the e-mail image data received in step S202. Accordingly, a user can automatically read the e-mail received from the other party in the call through the display unit 16 even during response to the call.

In step S207, the e-mail data received in step S202 is stored in the e-mail data storage region 33. Specifically, in step S202, the date of reception when the e-mail is received is acquired. The date of reception, although not illustrated, is date information determined by the information processing apparatus 10. This date information may be set by a user of the information processing apparatus, or may be automatically set through the Internet. The address ID that corresponds to the e-mail address included in the received e-mail is determined among the personal information storage region 31. In step S202, the information stored in the received information temporary storage region 22 is stored in the e-mail data storage region 33. In correspondence to the e-mail address included in the received e-mail data or the determined address ID, the e-mail image data, the attached file, and the date of reception are stored in the e-mail data storage region 33.

In the first embodiment, it is exemplified that in steps S112 and S115, the received fax data or e-mail data is stored in the fax data storage region 32 or e-mail data storage region 33. However, an aspect of the present invention is not limited thereto. For example, in steps S112 and S115, it is sufficient if the transmission and reception of the fax or e-mail may be determined. In this case, in step S113, in correspondence to the phone number that indicates the transmitter of the fax, the fax image data is stored in the fax data storage region 32. In step S116, in correspondence to the e-mail address that indicates the transmitter of the e-mail, the e-mail image data is stored in the e-mail data storage region 33. In this case, in step S107, information is acquired among the fax image data and e-mail image data transmitted or received by the information processing apparatus 10. The information acquired in step S107 is displayed on the display unit 16 through the process in steps S108 and S109.

In the first embodiment, it is exemplified that after the processing from step S106 to step S109 is performed, the phone connection processing in step S110 is performed. However, an aspect of the present invention is not limited thereto. For example, after the phone connection processing in step S110 is performed, the processing from step S106 to step S109 may be performed.

### Second Embodiment

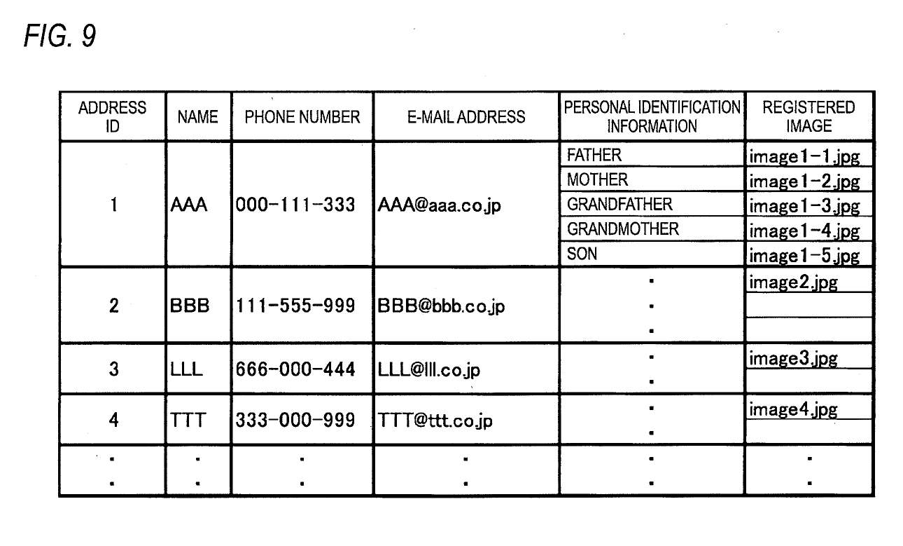

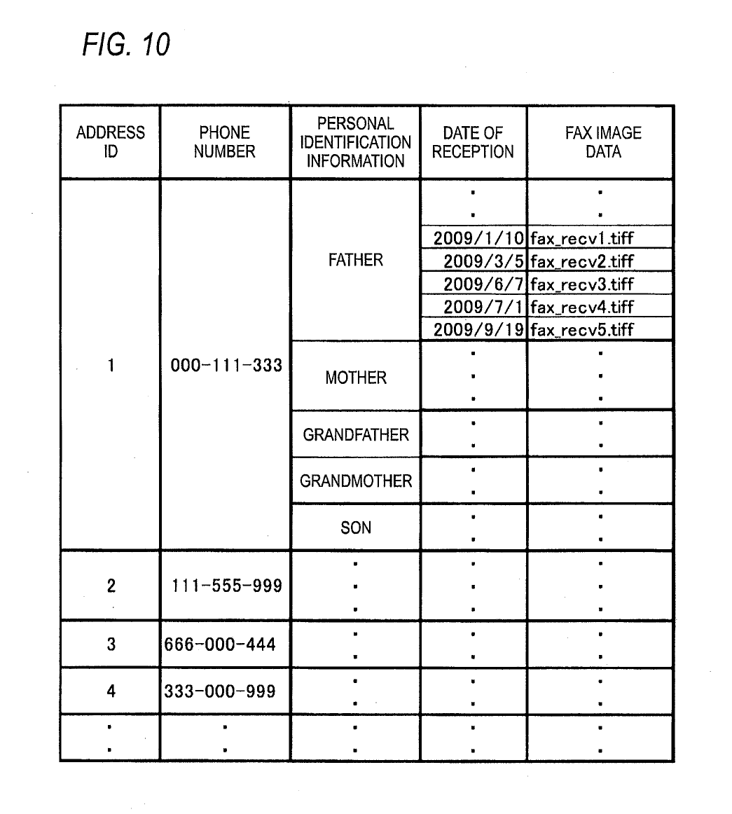

Hereinafter, the second embodiment will be described based on FIGS. 9 to 13. Hereinafter, with respect to the second embodiment, only points that are different from those in the first embodiment will be described. The external appearance of the information processing apparatus 10 according to the second embodiment is the same as the external appearance of the information processing apparatus according to the first embodiment as illustrated in FIG. 1. In the second embodiment, the fax and the e-mail received by the information processing apparatus 10 include the personal identification information. Based on this, explanation will be made as follows. The details of the personal identification information will be described later.

Electrical Configuration of Information Processing Apparatus 10 according to the Second Embodiment

The electrical configuration of the information processing apparatus 10 according to the second embodiment is the same as the electrical configuration of the information processing apparatus according to the first embodiment as shown in FIG. 2. The second embodiment is different from the first embodiment on the point of the storage state of information respectively stored in the personal information storage region 31, the fax data storage region 32, and the e-mail data storage region 33.

FIG. 9 shows the storage state where the personal information is stored. The second embodiment is different from the first embodiment on the point that the address ID, the phone number, or the e-mail address corresponds to one or more personal identification information, and is stored in the personal information storage region 31.

As illustrated in FIG. 9, in the same manner as the first embodiment, the address ID, the name, the phone number, and the e-mail address correspond in one-to-one manner. In the second embodiment, it is assumed that one phone number is allocated to one or more persons. That is, the name indicated in FIG. 9 is registered as the name of the representative among one or more personal identification information. In the general home, a plurality of users exists with respect to one phone number. The second embodiment can correspond to such a case. The address ID, the phone number, or the e-mail address of FIG. 9 corresponds to “father”, “mother”, “grandfather”, “grandmother”, and “son”, as one or more personal identification information. In an example of FIG. 9, it is exemplified that the information processing apparatus 10 is used in the home. However, the present invention can be applied to any other example in addition to the home. For example, the name of a person may be used as the personal identification information.

The conceptual view of the second embodiment as illustrated in FIG. 9 is different from that of the first embodiment on the points that the address ID or the phone number corresponds to one or more personal identification information. For the identification information, the received fax image and the date of reception are classified and stored.

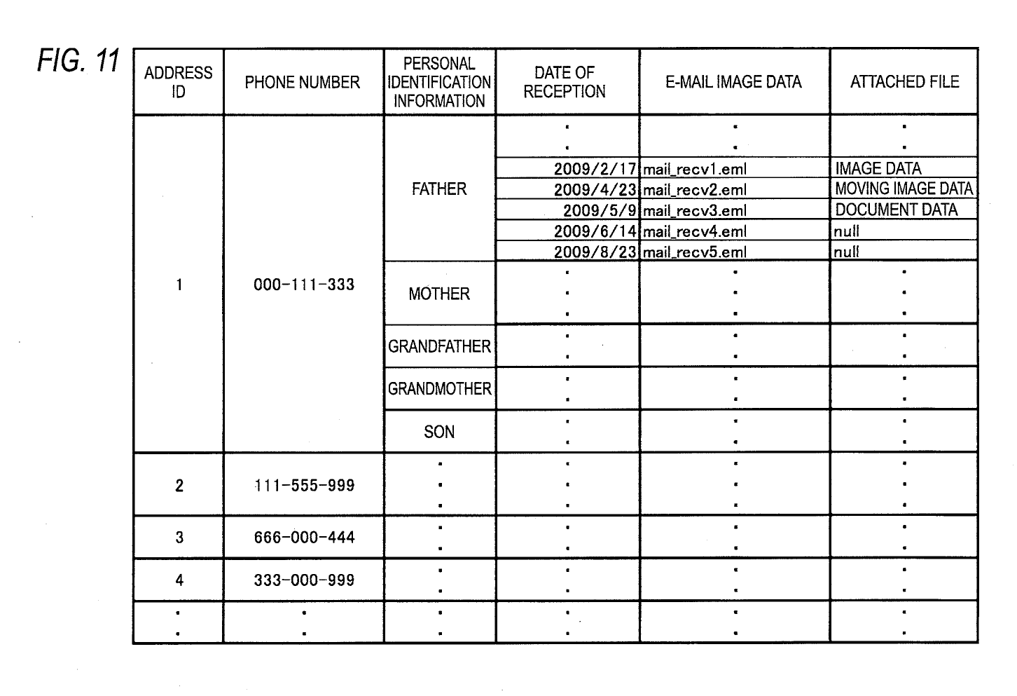

The conceptual view of the second embodiment as illustrated in FIG. 11 is different from that according to the first embodiment on the point that the address ID or the e-mail address corresponds to one or more personal identification information. For the personal identification information, the date of reception, the received e-mail image data, and the attached file are classified and stored.

### Main Processing Operation of Information Processing Apparatus 10 According to Second Embodiment

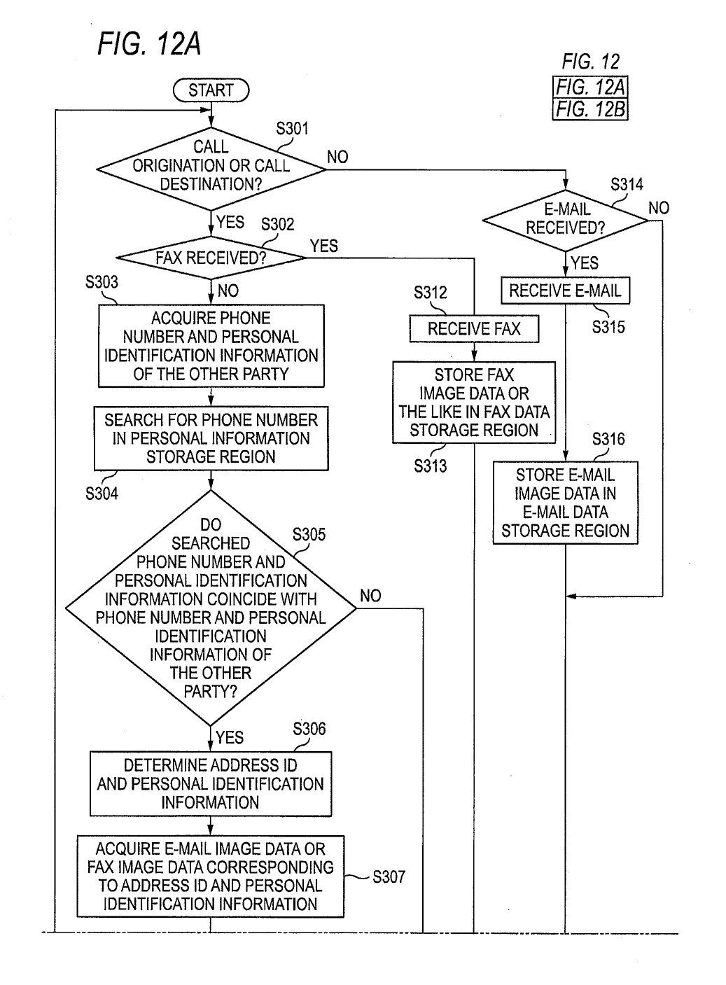

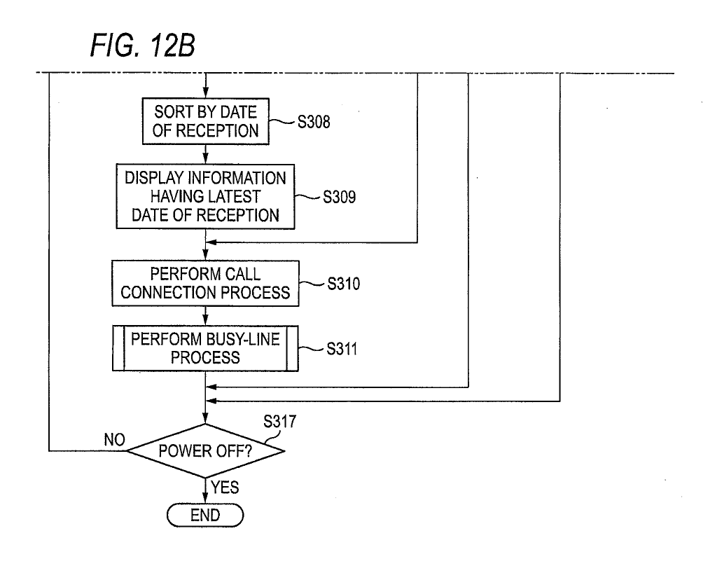

The operation and effect of the information processing apparatus 10 according to the second embodiment as configured above will be described with reference to the accompanying drawings. The main processing operation as illustrated in FIG. 12 is performed according to a main processing operation program. Based on the power-on of the information processing apparatus 10, the main processing operation of the information processing apparatus 10 is performed. The CPU 1 executes the main operation program as follows.

In step S301, in the same manner as the step S101, it is determined whether a call or fax is received from another apparatus to the information processing apparatus 10, or whether a call or fax is originated from the information processing apparatus 10 to another apparatus. The second embodiment is different from the first embodiment on the point that a person of the other party in the call is identified when the call or fax origination or the call or fax destination is performed. Accordingly, when the call or fax origination is performed in step S101, the personal identification information is transmitted to the originator. In the case of the destination, the personal identification information is transmitted from another apparatus to the information processing apparatus 10.

Step S302 is the same process as step S102.

In step S303, a phone number and personal identification information of the other party in the call are acquired. In the case of a call destination, another apparatus that has originated the call transmits the phone number and the personal identification information of another apparatus to the information processing apparatus 10. The phone number and the personal identification information transmitted to the information processing apparatus 10 are acquired in step S303. The acquired phone number and the personal identification information are temporarily stored in the call identification information temporary storage region 21. On the other hand, in the case of a call origination, the phone number determined as the originator in step S301 and the personal identification information are temporarily stored in the call identification information temporary storage region 21.

In step S304, it is searched for whether the information that coincides with the phone number acquired in step S303 and the personal identification information are stored in the personal information storage region 31. Specifically, the phone number and the personal identification information stored in the call identification information temporary storage region 21 are compared with the information stored in the personal information storage region 31.

In step S305, it is determined whether the phone number and the personal identification information that coincide with the call identification information temporary storage region 21 as a result of search in step S304 exist in the personal information storage region 31. As a result of comparison in step S304, if the phone number and the personal identification information stored in the call identification information temporary storage region 21 coincide with the phone number and the personal identification information stored in the personal information storage region 31, it is determined that the coincident information exists. When it is determined that the coincident information exists, step S306 is performed. If it is not determined that the coincident information exists, step S310 is performed.

In step S306, an address ID of the phone number and the personal identification information that are determined as the coincident information in step S305 are determined. The personal identification information of the information that is determined as the coincident information in step S305 is determined. Hereinafter, explanation will be made on the assumption that the address ID determined in step S305 is “1” and the personal identification information is “father”.

In step S307, the fax image data and the date of reception that correspond to the address ID determined in step S306 and the personal identification information are acquired from the fax data storage region 32. The e-mail image data and the date of reception that correspond to the address ID and the personal identification information are acquired from the e-mail data storage region 33. Specifically, fax image data, such as “fax_recv1.tiff”, “fax_recv2.tiff”, and the like, which is the fax image data corresponding to the address ID “1” and the personal identification information “father”, is acquired. In the same manner, “image data”, “moving image data”, and the like, which is the e-mail image data corresponding to the address ID “1” and the personal identification information “father”, is acquired. The acquired data is temporarily stored in the display information temporary storage region 23.

Thereafter, the processing in steps 5308 to 5310 is the same as the processing in steps S108 to S110.

In step S311, the busy-line processing is performed. The details of the busy-line processing will be described later.

In step S312, the fax image data is received. The received fax image data includes a phone number of a fax transmitter, personal identification information, and fax image data.

In step S313, the fax received in step S312 is stored in the fax data storage region 32. Specifically, the date of reception when the fax is received in step S312 is acquired. The date of reception, although not illustrated, is date information determined by the information processing apparatus 10. This date information may be set by a user of the information processing apparatus, or may be automatically set through the Internet. The address ID that corresponds to the phone number included in the received fax is determined among the personal information storage region 31. In correspondence to the phone number included in the received fax, determined address ID, or the personal identification information included in the received fax, the fax image data and the date of reception are stored in the fax data storage region 32.

Step S314 is the same processing as step S114.

In step S315, the e-mail image data is received. The received e-mail image data includes an e-mail address of an e-mail transmitter, personal identification information, and e-mail image data.

In step S316, the e-mail received in step S315 is stored in the e-mail data storage region 33. Specifically, in step S315, the date of reception when the e-mail is received is acquired. The date of reception, although not illustrated, is date information determined by the information processing apparatus 10. This date information may be set by a user of the information processing apparatus, or may be automatically set through the Internet. The address ID that corresponds to the e-mail address included in the received e-mail is determined among the personal information storage region 31. In correspondence to the e-mail address included in the received e-mail or the determined address ID and the personal identification information included in the received e-mail, the e-mail image data, the attached file, and the date of reception are stored in the e-mail data storage region 33.

Step S317 is the same processing as step S117.

### Busy-Line Processing According to the Second Embodiment

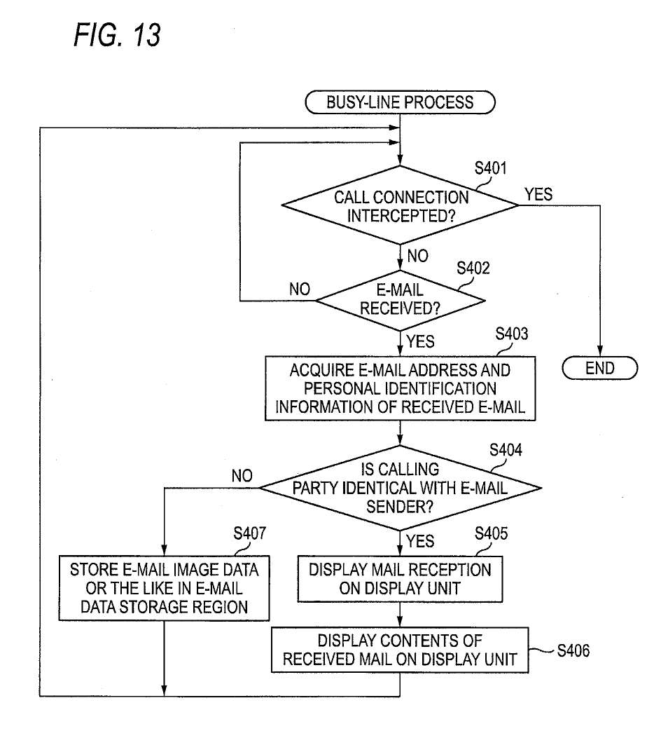

The busy-line processing as illustrated in FIG. 13 is performed according to a busy-line processing program. Steps S401 and 5402 are the same processing as steps S201 and S202.

In step S403, the e-mail address and the personal identification information received in step S402 are acquired. Specifically, the e-mail address and the personal identification information received in step S402 are temporarily stored in the received information temporary storage region 22. The e-mail data received in step S402 includes the header, the text information, and the personal identification information as described above. The text information of the e-mail and the attached file are temporarily stored in the received information temporary storage region 22.

In step S404, it is determined whether the transmitter of the e-mail received in step S403 coincides with the other party in the call. Specifically, information, which coincides with the e-mail address and the personal identification information acquired in step S403, is searched for in the personal information storage region 31. If the information, which coincides with the e-mail address and the personal identification information acquired in step S403, exists in the personal information storage region 31, one or more phone numbers that coincide with the e-mail address and the personal information are acquired. It is determined whether the acquired phone number and the personal identification information acquired in step S403 coincide with the phone number and the personal identification information stored in the call identification information temporary storage region 21, respectively. If it is determined that they coincide with each other, step S405 is performed. If it is determined that they do not coincide with each other, step S407 is performed.

Steps S405 and S406 are the same processing as steps S205 and S206.

In step S407, the e-mail image data received in step S402 is stored in the e-mail data storage region 33. Specifically, in step S402, the date of reception when the e-mail is received is acquired. The date of reception, although not illustrated, is date information determined by the information processing apparatus 10. This date information may be set by a user of the information processing apparatus, or may be automatically set through the Internet. The address ID that corresponds to the e-mail address included in the received e-mail is determined among the personal information storage region 31. In step S402, the information stored in the received information temporary storage region 22 is stored in the e-mail data storage region 33. In correspondence to the e-mail address included in the received e-mail data or the determined address ID and the personal identification information included in the received e-mail, the e-mail image data, the attached file, and the date of reception are stored in the e-mail data storage region 33.

Modified examples of the first embodiment and the second embodiment will be described. In the first embodiment and the second embodiment, it is exemplified that the call and the fax are performed through the phone line communication unit 6. However, the present invention is not limited thereto. As a modified example, the call and the fax may be performed through the Internet communication unit 5, for example, an IP phone, an IP-FAX, and the like.

Modified examples of the step S206 according to the first embodiment and the step S406 according to the second embodiment will be described. In the step S206 according to the first embodiment and the step S406 according to the second embodiment, it is exemplified that the e-mail data received by the information processing apparatus 10 is displayed. As a modified example, if the received e-mal includes an attached file, the attached file may be preferentially displayed on the display unit 16. This is because it is general that display information that is more important than the mail text is attached to the text as the attached file.

What is claimed is:

1. An information processing apparatus comprising:
a first acquisition unit configured to acquire call identification information for identifying a caller during a call;
a first storage unit configured to store first location information indicating a location on a network,
a second acquisition unit configured to acquire, from the first storage unit, the first location information corresponding to the call identification information acquired by the first acquisition unit;
a reception unit configured to receive, from another apparatus that is connected to the information processing apparatus through the network, display information which includes second location information indicating a location on the network of said another apparatus;
a first determination unit configured to determine whether the second location information received by the reception unit coincides with the first location information stored in the first storage unit; and
a supply unit configured to supply a display signal for displaying the display information received by the reception unit to a display unit during the call if the first determination unit determines that the second location information coincides with the first location information.

2. The information processing apparatus according to claim 1 further comprising:
a calling unit configured to perform the call with the caller through a phone line which is different from the network; and
a second determination unit configured to determine whether the call is being performed through the calling unit,
wherein the supply unit supplies the display signal to the display unit if the second determination unit determines that the call is being performed and the first determination unit determines that the second location information coincides with the first location information.

3. The information processing apparatus according to claim 1, wherein
the first storage unit stores first identification information for identifying one or more persons corresponding to the first location information,
the reception unit acquires the second location information and second identification information for identifying a sender sending the display information,
the first determination unit determines whether the second identification information received by the reception unit coincides with the first identification information stored in the first storage unit; and
the supply unit supplies the display signal to the display unit if the first determination unit determines that the second location information coincides with the first location information and determines that the first identification information coincides with the second identification information.

4. The information processing apparatus according to claim 3 further comprising:
a second storage unit configured to store the display information received by the receiving unit with being associated with the first identification information; and
a first deciding unit configured to decide the first identification information that corresponds to the first location information acquired by the first acquisition unit,
wherein the supply unit reads out the display information that corresponds to the first identification information decided by the first deciding unit from the second storage means and supplies the read-out display signal to the display unit.

5. The information processing apparatus according to claim 4, wherein
the second storage unit stores the display information received by the reception unit with being associated with date information that indicates a date of reception of the display information;
the information processing apparatus further comprises a second deciding unit decides the display information whose corresponding date information including dates in a predetermined range from the current date among the display information decided by the first deciding unit; and
the supply unit supplies the display signal for displaying the display information determined by the second determination unit to the display unit.

6. The information processing apparatus according to claim 4, further comprising a reception determination unit configured to determine whether the reception unit receives the display information while the supply unit supplies the display information determined by the first deciding unit,
wherein if the determination unit determines that the reception unit receives the display information, the determination unit determines whether the second location information coincides with the first location information; and
wherein if the determination unit determines that the second location information coincides with the first location information, the supply unit supplies the display signal for displaying the display information received by the reception unit to the display unit.

7. The information processing apparatus according to claim 1, wherein
the reception unit receives an e-mail as the display information; and
if the determination unit determines that the second location information coincides with the first location information, the supply unit displays the e-mail received by the reception unit to the display unit.

8. The information processing apparatus according to claim 7, wherein
the e-mail includes text information indicated by text in the e-mail and the display information attached to the e-mail, and
if the determination unit determines that the second location information coincides with the first location information, the supply unit displays the display information attached to the email received by the reception unit.

9. An information processing method comprising:
acquiring call identification information for identifying a caller during a call;
acquiring, from a storage unit, first location information corresponding to the acquired call identification information;
receiving, from another apparatus that is connected to the information processing apparatus through the network, display information which includes second location information indicating a location on the network of said another apparatus;
determining whether the received second location information coincides with the acquired first location information; and
supplying a display signal for displaying the received display information to a display unit during the call if it is determined that the second location information coincides with the first location information.

10. A non-transitory computer readable recording medium storing a program for causing a computer to execute:
acquiring call identification information for identifying a caller during a call;
acquiring, from a storage unit, first location information corresponding to the acquired call identification information;
receiving, from another apparatus that is connected to the information processing apparatus through the network, display information which includes second location information indicating a location on the network of said another apparatus;
determining whether the received second location information coincides with the acquired first location information; and
supplying a display signal for displaying the received display information to a display unit during the call if it is determined that the second location information coincides with the first location information.
